(19) United States
(12) Patent Application Publication
(10) Pub. No.: US 2010/0072661 A1
(43) Pub. Date: Mar. 25, 2010

(54) Method of manufacturing mold for nano imprint and pattern forming method using the mold for nano imprint

(75) Inventors: Young Tae Cho, Suwon-si (KR); Jeong Gil Kim, Suwon-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 12/461,989

(22) Filed: Aug. 31, 2009

(30) Foreign Application Priority Data
Sep. 22, 2008 (KR) 10-2008-0092498

(51) Int. Cl. B29C 33/42

(52) U.S. Cl. 264/219

(57) ABSTRACT

Disclosed herein are a method of manufacturing various replica molds for nano imprint using nano imprint and etching and a method of forming a multi-step pattern or a micro pattern through a nano imprint process using the manufactured replica molds for nano imprint. A pattern forming method using nano imprint may include applying a mold resin between a substrate having a first pattern patterned thereon and a master mold with a second pattern patterned thereon, aligning the substrate and the master mold to imprint a pattern, curing the mold resin, separating the master mold from the substrate, and etching the cured mold resin to manufacture a replica mold for nano imprint. The method may also include forming an imprint resin on a forming substrate, pressing the replica mold into the imprint resin, curing the imprint resin, separating the replica mold from the imprint resin, and washing the first imprint resin.

### CROSS-REFERENCE TO RELATED APPLICATION

This application claims priority under 35 U.S.C. §119 to Korean Patent Application No. 10-2008-0092498, filed on Sep. 22, 2008 in the Korean Intellectual Property Office (KIPO), the entire contents of which are herein incorporated by reference.

### BACKGROUND

1. Field

Example embodiments of the present invention relate to a method of manufacturing various replica molds for nano imprint using nano imprint and dry etching. Example embodiments of the present invention also relate to a method of forming a multi-step pattern or a micro pattern through a nano imprint process using the manufactured replica molds for nano imprint.

2. Description of the Related Art

A conventional nano imprint process utilizes a replica mold, manufactured from a master mold, to form patterns having a nano size of 1 to 100 nm. When using a three-dimensional mold, forming a three-dimensional pattern may be relatively easy. Also, when using a mold having a micro line width of 30 nm or less, forming a pattern having a micro line width which may not be implemented by another process may be possible, for example, a photolithography process. Consequently, the nano imprint process may be carried out with relatively high productivity and relatively low costs. For this reason, the nano imprint process may be used to manufacture semiconductors or flat panel displays.

A mold having a desired pattern may be necessary to form a pattern using the nano imprint process. For example, E-beam lithography or focused ion beam lithography may be used to manufacture a mold having a micro line width. However, manufacturing a pattern of 50 nm or less when using the E-beam lithography or the focused ion beam lithography, which has a resolution of several nanometers, may be difficult. Also, repeatedly performing an exposing process or performing a laser process may be necessary, which may be a relatively high-cost process, to manufacture a mold having a three-dimensional pattern, for example, a multi-step pattern.

### SUMMARY

Example embodiments of the invention to provide a method of manufacturing various replica molds for nano imprint using a combination of nano imprint and dry etching and a method of forming a micro pattern or a multi-step pattern through a nano imprint process using the manufactured replica molds for nano imprint. Additional aspects of the invention will be set forth in part in the description which follows and, in part, will be obvious from the description, or may be learned by practice of the invention.

In accordance with example embodiments of the present invention, a method of manufacturing a mold for nano imprint may include applying a mold resin between a substrate having a first pattern patterned thereon and a master mold with a second pattern patterned thereon, aligning the substrate and the master mold to imprint a pattern, curing the mold resin, separating the master mold from the substrate, and etching the cured mold resin to manufacture a replica mold for nano imprint.

In accordance with example embodiments of the present invention, a pattern forming method using nano imprint may include applying a mold resin between a substrate having a first pattern patterned thereon and a master mold with a second pattern patterned thereon, aligning the substrate and the master mold to imprint a pattern, curing the mold resin, separating the master mold from the substrate, and etching the cured mold resin to manufacture a replica mold for nano imprint. The method may also include forming an imprint resin on a forming substrate, joining the replica mold and the first forming substrate by pressing the replica mold into the imprint resin, curing the imprint resin, separating the replica mold from the imprint resin, and washing the first imprint resin to remove uncured resin.

In accordance with example embodiments of the present invention, a pattern forming method using nano imprint may include etching a mold resin on a substrate having a metal pattern patterned thereon to manufacture a mold, applying an imprint resin to a forming substrate, pressing the forming substrate having the imprint resin applied thereto, using the mold, to imprint a pattern, and separating the mold from the forming substrate.

In accordance with example embodiments of the present invention, a method of manufacturing a mold for nano imprint may include applying a mold resin between a substrate having a metal pattern patterned thereon and a master mold, aligning the substrate and the master mold to imprint a pattern, curing the mold resin, and separating the master mold from the substrate and etching the cured mold resin to manufacture a replica mold for nano imprint.

Aligning the substrate and the master mold may include aligning the substrate and the master mold such that patterns formed on the substrate and the master mold are offset from each other.

The pattern may have a shape depending on the offset degree between the substrate and the master mold.

The pattern may have a line width depending on the offset degree between the substrate and the master mold.

Manufacturing the replica mold for nano imprint may include performing a dry etching process using a gas that may etch the mold resin, until the residual resin is not completely removed but is left to some extent, to manufacture the replica mold having a multi-step pattern.

Manufacturing the replica mold for nano imprint may include performing a dry etching process using a gas that may etch the mold resin, until the residual resin is completely removed, to manufacture the replica mold having a micro pattern.

The method may further include etching the metal pattern to completely remove the metal pattern.

The method may further include surface-treating the etched replica mold using an anti adhesion layer.

In accordance with another aspect of the present invention, a pattern forming method using nano imprint may include etching a mold resin on a substrate having a metal pattern patterned thereon to manufacture a mold, applying an imprint resin to a forming substrate, pressing the forming substrate having the imprint resin applied thereto, using the mold, to imprint a pattern, and separating the mold from the forming substrate.

The imprint resin may be UV-curable.

The forming substrate may have a multi-step pattern formed through a nano imprint process.

The forming substrate may have a micro pattern formed through a nano imprint process.

The mold resin may be coated with an anti adhesion layer, whereby the mold exhibits a separation property.

According to example embodiments of the present invention, it may be possible to easily manufacture various molds to which it may be difficult to apply a nano imprint process. Example embodiments of the present invention use a combination of nano imprint and dry etching to form a micro pattern or a multi-step pattern through a nano imprint process using the manufactured molds without the repetition of complicated processes. Accordingly, example embodiments of the present invention provide a new process to manufacture a new device. The process may be applicable to a semiconductor process or a display manufacturing process requiring a micro pattern or a multi-step pattern. Also, an economical effect as well as a technical effect may be obtained through the improvement of production yield and the reduction of costs.

### BRIEF DESCRIPTION OF THE DRAWINGS

These and/or other aspects of the invention will become apparent and more readily appreciated from the following description of the example embodiments of the present invention, taken in conjunction with the accompanying drawings, of which:

FIGS. 1A to 1F are process views illustrating a method of manufacturing a replica mold for nano imprint according to example embodiments of the present invention;

FIGS. 2A to 2D are process views illustrating a method of forming a multi-step pattern using a replica mold for nano imprint according to example embodiments of the present invention;

FIGS. 3A to 3D are process views illustrating a method of forming a micro pattern using a replica mold for nano imprint according to example embodiments of the present invention;

FIG. 4 is a flow chart illustrating a method of forming a multi-step pattern or a micro pattern using a nano imprint process according to example embodiments of the present invention shown in FIGS. 2A to 2D or FIGS. 3A to 3D; and

FIGS. 5A and 5B are process views illustrating a method of forming a micro pattern using an etching process according to example embodiments of the present invention.

### DETAILED DESCRIPTION

Example embodiments of the present invention will now be described more fully with reference to the accompanying drawings, in which example embodiments of the present invention are shown. Example embodiments of the present invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the sizes of components may be exaggerated for clarity.

It will be understood that when an element or layer is referred to as being “on”, “connected to”, or “coupled to” another element or layer, it can be directly on, connected to, or coupled to the other element or layer or intervening elements or layers that may be present. In contrast, when an element is referred to as being “directly on”, “directly connected to”, or “directly coupled to” another element or layer, there are no intervening elements or layers present. As used herein, the term “and/or” includes any and all combinations of one or more of the associated listed items.

It will be understood that, although the terms first, second, etc. may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section. Thus, a first element, component, region, layer, or section discussed below could be termed a second element, component, region, layer, or section without departing from the teachings of the example embodiments of the present invention.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Embodiments described herein will refer to plan views and/or cross-sectional views by way of ideal schematic views. Accordingly, the views may be modified depending on manufacturing technologies and/or tolerances. Therefore, example embodiments are not limited to those shown in the views, but include modifications in configuration formed on the basis of manufacturing processes. Therefore, regions exemplified in figures have schematic properties and shapes of regions shown in figures exemplify specific shapes or regions of elements, and do not limit example embodiments of the present invention.

Reference will now be made in detail to example embodiments of the present invention, examples of which are illustrated in the accompanying drawings, wherein like reference numerals refer to the like elements throughout.

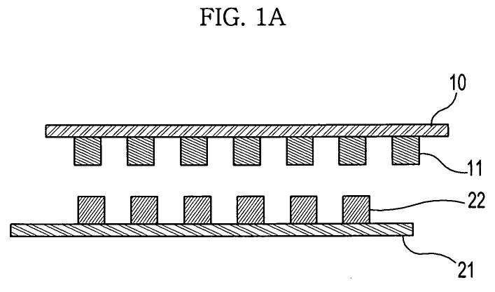

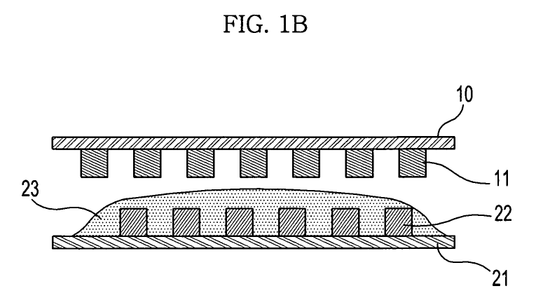

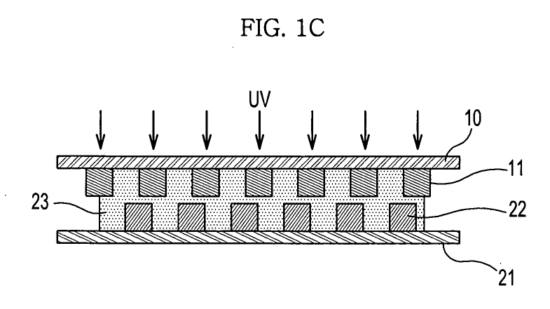

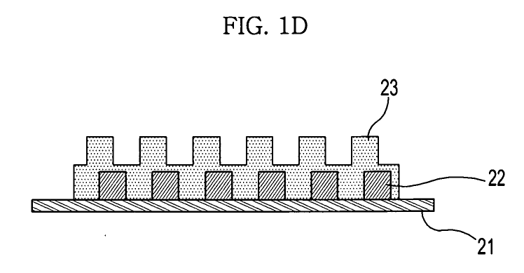

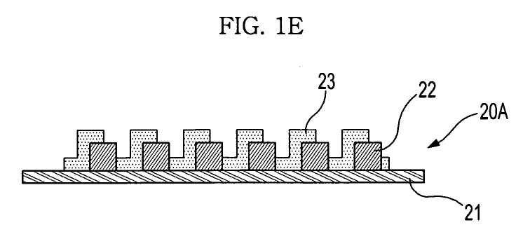

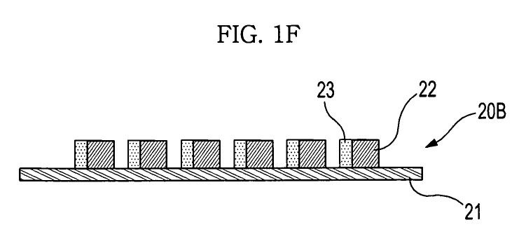

FIGS. 1A to 1F are process views illustrating a method of manufacturing a replica mold for nano imprint using nano imprint and dry etching processes according to example embodiments of the present invention.

In FIG. 1A, a master mold 10 and a substrate 21 are prepared. The master mold 10 and the substrate 21 may be manufactured as a structure in which patterns 11 and 22 are formed on the master mold 10 and the substrate 21 through a patterning process. For example, the patterns 11 and 12 may be formed by photolithography, nano imprint lithography, or E-beam lithography. In accordance with example embodiments of the present invention, the patterns 11 and 22 may be metal patterns.

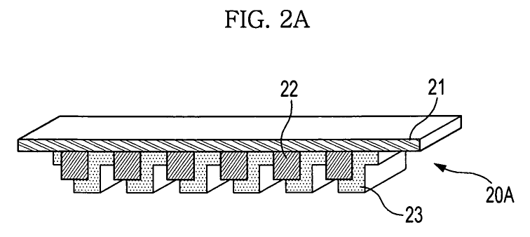

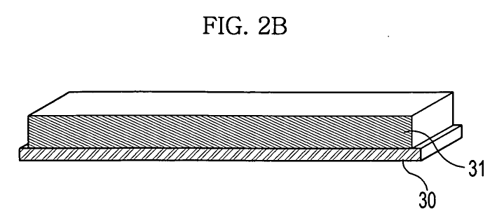

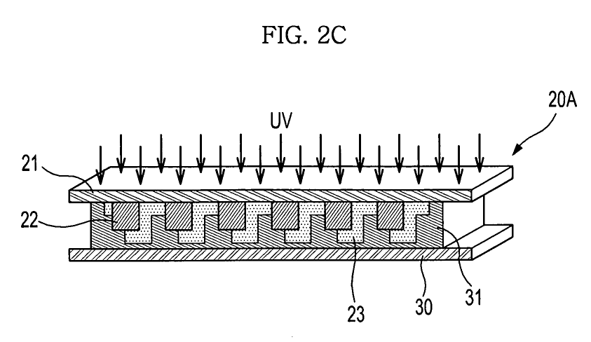

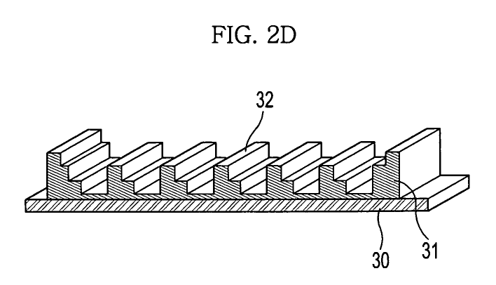

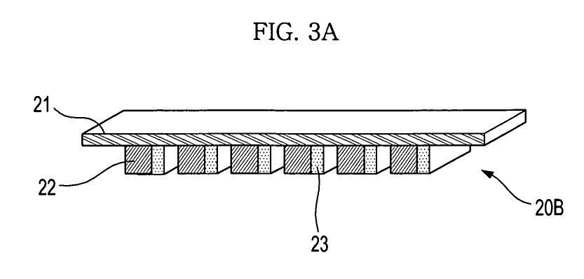

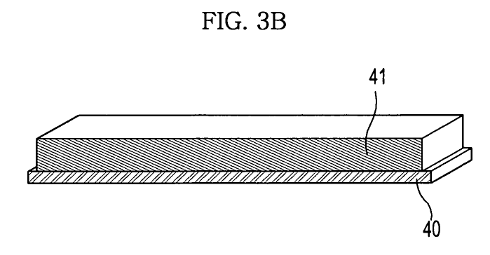

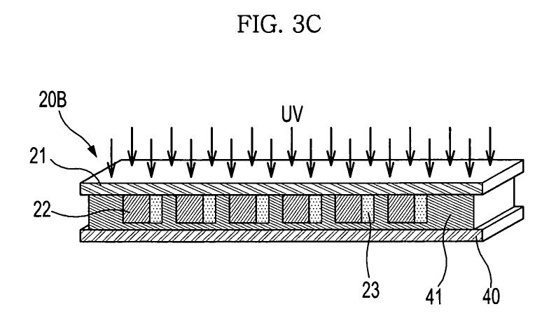

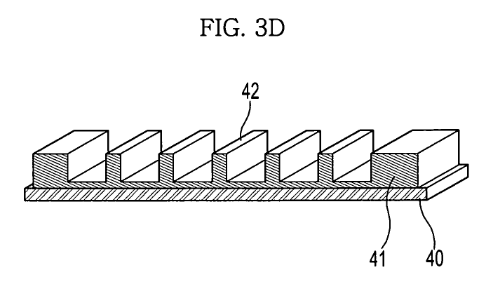

In FIG. 1B, an ultraviolet (UV)-curable mold resin 23 may be applied between the master mold 10 and the substrate 21, and the master mold 10 and the substrate 21 may be aligned with each other such that the patterns 11 and 22 are offset from each other. The shape and size of patterns 32 (see FIG. 2D) and 42 (see FIG. 3D) may depend on the offset degree between the patterns 11 and 22.

In FIG. 1C, the master mold 10 and the substrate 21, which may be aligned with each other as shown in FIG. 1B, may be joined to each other. The mold resin 23 may be applied between the master mold 10 and the substrate 21. The mold resin 23 may be pressed, using the master mold 10, to imprint a pattern on the mold resin 23. Subsequently, UV rays may be irradiated at the master mold 10 side to cure the mold resin 23.

In FIG. 1D, the master mold 10 may be separated from the mold resin 23. As a result, the mold resin 23 may be patterned on the substrate 21 having the pattern 22 patterned thereon. An adhesion promoter may be used to increase the adhesion strength between the pattern 22 and the mold resin 23.

In FIG. 1E, a dry etching process, for example, reactive ion etching (RIE), may be performed using a gas that may etch only the mold resin 23. A pattern 32 (see FIG. 2D), which may be formed afterward, may depend on the etching degree. FIG. 1E shows that the dry etching process may be performed to partially remove the residual resin. In other words, the dry etching process may be performed such that not all of the residual resin is removed. This process may be used to form a first replica mold 20A for nano imprint (hereinafter, referred to as a first mold for nano imprint) having a multi-step shaped three-dimensional pattern.

In FIG. 1F, a dry etching process, for example, RIE, may be performed using a gas to etch only the mold resin 23, as in FIG. 1E. A pattern 42 (see FIG. 3D), which may be formed afterward, may depend on the etching degree. FIG. 1F shows that a dry etching process may be performed until the substrate 21 covered by the mold resin 23 is exposed to complete a second replica mold 20B for nano imprint (hereinafter, referred to as a second mold for nano imprint) having a micro pattern.

FIGS. 2A to 2D are process views illustrating a method of forming a multi-step pattern using a replica mold for nano imprint according to an embodiment of the present invention.

In FIG. 2A, a first mold 20A for nano imprint having a multi-step shaped three-dimensional pattern completed according to example embodiments of the present invention shown in FIGS. 1A to 1E may be prepared.

In FIG. 2B, a first UV-curable imprint resin 31 may be applied to a first forming substrate 30, on which a multi-step shaped three-dimensional pattern may be formed. The first forming substrate 30 may be made of a material to which a UV nano imprint process may be easily carried out. For example, a flat substrate made of glass, quartz, or metal through which UV rays may be transmitted or a flexible substrate made of Poly Ethylene Terephthalate (PET) or Poly Ethylene Naphthalate (PEN) may be used as the first forming substrate 30. Like the mold resin 23 patterned to manufacture the first mold 20A for nano imprint, a UV-curable polymer resin may be used as the first imprint resin 31. The mold resin 23 patterned on the first mold 20A and the first imprint resin 31 applied to the first forming substrate 30 may be made of different materials to prevent or reduce the adhesion between the mold resin 23 patterned on the first mold 20A and the first imprint resin 31 applied to the first forming substrate 30. Additionally, the mold resin 23 of the first mold 20A for nano imprint may be coated with an anti adhesion layer so that the mold resin 23 patterned on the first mold 20A for nano imprint may be easily separated from the first imprint resin 31 applied to the first forming substrate 30, when the mold resin 23 patterned on the first mold 20A for nano imprint and the first imprint resin 31 applied to the first forming substrate 30 are made of the same material.

In FIG. 2C, the first mold 20A for nano imprint, having the multi-step shaped three-dimensional pattern, may be joined to the first forming substrate 30. The first imprint resin 31 applied to the first forming substrate 30 may be pressed, using the first mold 20A for nano imprint, to imprint a pattern on the first imprint resin 31. Subsequently, parallel UV rays may be irradiated to the first mold 20A for nano imprint at the substrate 21 side thereof. The UV rays may not be transmitted through the region where the pattern 22 is located. Accordingly, only the portions of the first imprint resin 31 aligned on the region where the patterns 22 are not patterned may be cured by the irradiated UV rays.

In FIG. 2D, the first mold 20A for nano imprint is separated from the first imprint resin 31. The uncured first imprint resin 31 may be removed by washing the first imprint resin 31 with alcohol. As a result, a multi-step shaped three-dimensional pattern 32 (hereinafter, referred to as a multi-step pattern) is formed on the first forming substrate 30 as shown in FIG. 2D.

FIGS. 3A to 3D are process views illustrating a method of forming a micro pattern using a replica mold for nano imprint according to example embodiments of the present invention.

In FIG. 3A, a second mold 20B for nano imprint having a micro pattern completed as shown in FIGS. 1A to 1F is prepared.

In FIG. 3B, a second UV-curable imprint resin 41 may be applied to a second forming substrate 40, on which a micro pattern will be formed. The mold resin 23 patterned on the second mold 20B and the second imprint resin 41 applied to the second forming substrate 40 may be made of different materials to prevent or reduce the adhesion between the mold resin 23 patterned on the second mold 20B and the second imprint resin 41 applied to the second forming substrate 40. Additionally, the mold resin 23 of the second mold 20B for nano imprint may be coated with an anti adhesion layer, by which the mold resin 23 patterned on the second mold 20B may be easily separated from the second imprint resin 41 applied to the second forming substrate 40. For example, the mold resin 23 of the second mold 20B may be coated when the mold resin 23 patterned on the second mold 20B and the second imprint resin 41 applied to the second forming substrate 40 are made of the same material.

In FIG. 3C, the second mold 20B may be joined to the second forming substrate 40. The second imprint resin 41 applied to the second forming substrate 40 may be pressed, using the second mold 20B, to imprint a pattern on the second imprint resin 41. Subsequently, parallel UV rays may be irradiated to the second mold 20B for nano imprint at the substrate 21 side thereof. The UV rays may not be transmitted through the region where the pattern 22 is located but through the region where the pattern 22 is not located. As a result, only the second imprint resin 41 aligned on the regions where the pattern 22 is not patterned may be cured by the irradiated UV rays.

In FIG. 3D, the second mold 20B for nano imprint may be separated from the second imprint resin 41, and the uncured second imprint resin 41 may be removed by washing the second imprint resin 41 with alcohol. As a result, a micro pattern 42 may be formed on the second forming substrate 40 as shown in FIG. 3D. The micro pattern 42 may be formed such that the micro pattern 42 has a line width of 25 nm or less when the pattern 11 of the master mold 10 has a size of 50 nm. Also, the micro pattern 42 may be formed such that the micro pattern 42 has a line width of 10 nm or less depending upon the offset degree when the imprinting of FIG. 1C is performed.

Hereinafter, a method of forming a multi-step pattern 32 or a micro pattern 42 through a nano imprint process using the first or second mold 20A or 20B for nano imprint with the above-stated construction will be described.

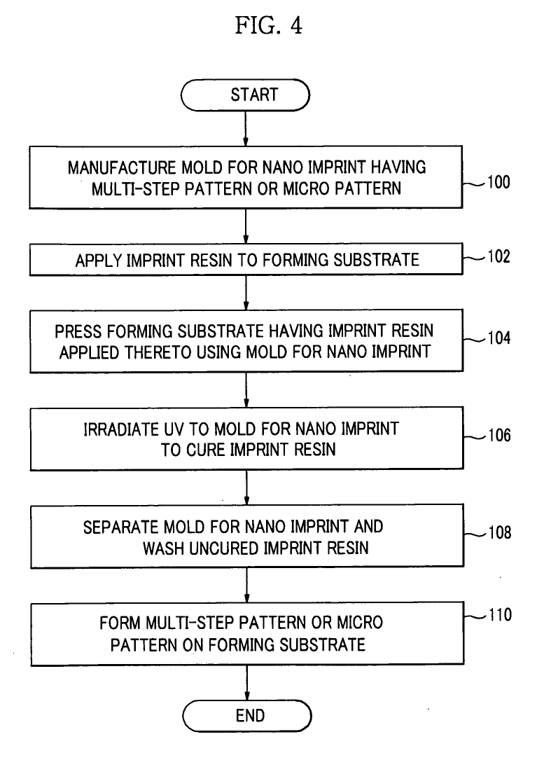

FIG. 4 is a flow chart illustrating a method of forming a multi-step pattern or a micro pattern using a nano imprint process according to example embodiments of the present invention as shown in FIGS. 2A to 2D or FIGS. 3A to 3D.

A first or second mold 20A or 20B for nano imprint having a multi-step pattern or a micro pattern may be manufactured according to the example embodiments of the present invention (100) (See FIGS. 1A to 1E or FIGS. 1A to 1F).

The first or second mold 20A or 20B for nano imprint having the multi-step pattern or the micro pattern may be constructed in a structure in which a mold resin 23 is etched at a substrate 21 having a pattern 22 patterned thereon. Consequently, it may be possible to manufacture a mold for nano imprint to which it may be difficult to apply a nano imprint process.

A first UV-curable imprint resin 31 or 41 may be applied to a substrate 30 or 40 on which a multi-step pattern or a micro pattern may be formed (102). The first or second mold 20A or 20B for nano imprint may be joined to the first or second forming substrate 30 or 40, and the first or second forming substrate 30 or 40 having the first or second imprint resin 31 or 41 applied thereto may be pressed using the first or second mold 20A or 20B for nano imprint (104).

Parallel UV rays may be irradiated to the first or second mold 20A or 20B for nano imprint at the substrate 21 side to cure the first or second imprint resin 31 or 41 (106).

The first or second mold 20A or 20B for nano imprint may be separated from the first or second imprint resin 31 or 41, and the uncured first or second imprint resin 31 or 41 may be washed using alcohol (108). As a result, a multi-step pattern 32 or a micro pattern 42 may be formed on the first or second forming substrate 30 or 40 (110) (See FIG. 2D or 3D).

After the multi-step pattern 32 or the micro pattern 42 is formed on the first or second forming substrate 30 or 40, the UV nano imprint process is completed.

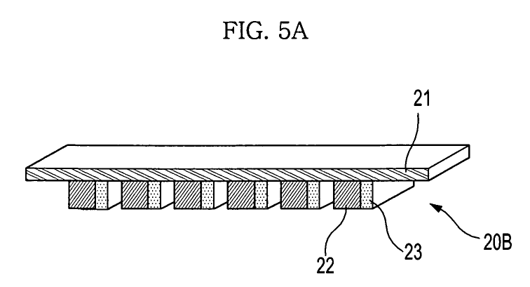

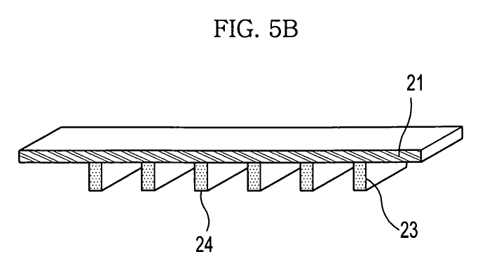

Hereinafter, another method of forming a micro pattern will be described with reference to FIGS. 5A and 5B.

FIGS. 5A and 5B are process views illustrating a method of forming a micro pattern using an etching process according to example embodiments of the present invention.

In FIG. 5A, a second mold 20B for nano imprint having a micro pattern completed according to example embodiments of the present invention shown in FIGS. 1A to 1F may be prepared.

In FIG. 5B, a substrate having a metal pattern 22 patterned thereon may be etched to manufacture a substrate having a mold resin 23 formed thereon in a micro pattern 24. The line width of the mold resin 23 formed in the micro pattern 24 may be adjusted depending upon the offset degree when the imprinting of FIG. 1C is performed.

As is apparent from the above description, forming a nano pattern or a three-dimensional micro pattern using the mold for nano imprint, having the multi-step pattern or the micro pattern, may be possible. Also, forming a complicated multi-step pattern through a single process, which may substitute for a relatively high-cost exposing process, may also be possible. Furthermore, implementing a pattern of 50 nm or less, which may be difficult to form by the existing exposing process, it may be possible. Therefore, the pattern may be used in the high integration of semiconductors. In addition, example embodiments of the present invention may be applicable to a semiconductor or display manufacturing process requiring a multi-step pattern. Therefore, easily and repeatedly manufacturing memory devices, thin-film transistors (TFTs), and optical patterns may be possible, thereby contributing to the reduction of process costs, the reduction of process time, and the improvement of production yield.

Although a few example embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of manufacturing a mold for nano imprint, comprising:
applying a mold resin between a substrate having a first pattern patterned thereon and a master mold with a second pattern patterned thereon;
aligning the substrate and the master mold to imprint a pattern;
curing the mold resin;
separating the master mold from the substrate; and
etching the cured mold resin to manufacture a replica mold for nano imprint.

2. The method according to claim 1, wherein aligning the substrate and the master mold comprises aligning the substrate and the master mold such that the first and second patterns formed on the substrate and the master mold are offset from each other.

3. The method according to claim 1, wherein etching the cured mold resin to manufacture a replica mold for nano imprint includes performing a dry etching process using a gas to partially remove the cured mold resin to manufacture the replica mold having a multi-step pattern.

4. The method according to claim 1, wherein etching the cured mold resin to manufacture a replica mold for nano imprint includes performing a dry etching process using a gas to completely remove a residual resin to manufacture the replica mold having a micro pattern.

5. The method according to claim 4, further comprising:
etching the first pattern to completely remove the first pattern.

6. The method according to claim 4, further comprising:
surface-treating the etched replica mold using an anti adhesion layer.

7. The method according to claim 3, further comprising:
surface-treating the etched replica mold using an anti adhesion layer.

8. The method according to claim 1, wherein the first pattern is a metal pattern.

9. A pattern forming method using nano imprint, comprising:
fabricating a replica mold in accordance with claim 1;
forming an imprint resin on a forming substrate;
joining the replica mold and the first forming substrate by pressing the replica mold into the imprint resin;
curing the imprint resin;
separating the replica mold from the imprint resin; and
washing the first imprint resin to remove uncured resin.

10. The method according to claim 9, wherein the replica mold is formed to have one of a multi-step pattern and a micro pattern.

11. The method according to claim 10, wherein joining the replica mold and the first forming substrate includes embedding the one of the multi-step pattern and the micro pattern in the imprint resin.

12. The method according to claim 11, wherein the first pattern is a metal pattern and regions of the imprint resin under the metal pattern are uncured.

13. The method according to claim 12, wherein washing the first imprint resin to remove uncured resin includes removing regions of the imprint resin under the metal pattern.

14. The method according to claim 9, wherein the imprint resin is a UV curable resin.

15. The method of claim 14, wherein the first pattern is a metal pattern and curing the imprint resin includes applying UV perpendicular to a surface of the substrate having the metal pattern to cure regions of the imprint resin adjacent to the metal pattern.

16. A pattern forming method using nano imprint, comprising:
etching a mold resin on a substrate having a metal pattern patterned thereon to manufacture a mold;
applying an imprint resin to a forming substrate;
pressing the forming substrate having the imprint resin applied thereto, using the mold, to imprint a pattern; and
separating the mold from the forming substrate.

17. The pattern forming method according to claim 16, wherein the imprint resin is UV-curable.

18. The pattern forming method according to claim 16, wherein the mold is configured to form a multi-step pattern formed in the imprint resin.

19. The pattern forming method according to claim 16, wherein the mold is configured to form a micro pattern in the imprint resin.

20. The pattern forming method according to claim 16, wherein the mold resin is coated with an anti adhesion layer and exhibits a separation property.
